(19) United States
(12) Patent Application Publication
(10) Pub. No.: US 2017/0350321 A1
(43) Pub. Date: Dec. 7, 2017

(54) Bundled Tube Fuel Nozzle Assembly with Tube Extensions

(71) Applicant: General Electric Company, Schenectady, NY (US)

(72) Inventors: Elizabeth Leigh Doering, Greenville, SC (US); Lucas John Stoia, Taylors, SC (US)

(21) Appl. No.: 15/171,202

(22) Filed: Jun. 2, 2016

(51) Int. Cl. F02C 7/22; F23R 3/28

(52) U.S. Cl. CPC F02C 7/222; F23R 3/28; F05D 2220/32

(57) ABSTRACT

A bundled tube fuel nozzle assembly includes a fuel plenum body defining a forward wall, an aft wall, an outer band, a fuel plenum defined within the fuel plenum body and a plurality of tubular passages that extends from the forward wall, through the fuel plenum and to the aft wall, wherein the fuel plenum body is formed as a singular body. The bundled tube fuel nozzle assembly further includes a plurality of tube extensions that extends downstream from the plurality of tubular passages. At least one tube extension of the plurality of tube extensions includes an upstream end that extends axially into a respective outlet of a respective tubular passage of the plurality of tubular passages.

### FIELD OF THE TECHNOLOGY

The present disclosure is directed to a bundled tube fuel nozzle assembly for a gas turbine combustor. More particularly, the present disclosure is directed a bundled tube fuel nozzle assembly with tube extensions.

### BACKGROUND

Particular combustion systems for gas turbine engines utilize combustors having bundled tube type fuel nozzle assemblies for premixing a gaseous fuel with a compressed air upstream from a combustion zone. A bundled tube fuel nozzle assembly generally includes multiple tubes that extend through a fuel plenum which is at least partially defined between a forward plate, an axially spaced aft plate and an outer sleeve. Each tube extends through a respective tube hole defined in the forward plate and a corresponding tube hole defined in the aft plate. During operation, compressed air flows into an inlet portion of each tube. Fuel from the fuel plenum is injected into each tube via a respective fuel port where it premixes with the compressed air before it is routed into the combustion zone.

In order to seal the fuel plenum, a first braze or weld joint is formed between each tube and the respective tube hole defined in the forward plate and a second braze or weld joint is formed between the tube and the corresponding tube hole defined in the intermediate plate. In various configurations, bundled tube fuel nozzle assemblies may include a large number of closely packed tubes. As such, hundreds of braze joints may be required to effectively seal the fuel plenum. Each braze joint provides a potential fuel leak point and may be generally difficult to form due to the close proximity of the tubes. Therefore, an improved bundled tube fuel nozzle assembly would be useful.

### BRIEF DESCRIPTION OF THE TECHNOLOGY

Aspects and advantages are set forth below in the following description, or may be obvious from the description, or may be learned through practice.

One embodiment of the present disclosure is a bundled tube fuel nozzle assembly. The bundled tube fuel nozzle assembly includes a fuel plenum body defining a forward wall, an aft wall, an outer band, a fuel plenum defined within the fuel plenum body and a plurality of tubular passages that extends from the forward wall, through the fuel plenum and to the aft wall, wherein the fuel plenum body is formed as a singular body. The bundled tube fuel nozzle assembly further includes a plurality of tube extensions that extends downstream from the plurality of tubular passages. At least one tube extension of the plurality of tube extensions includes an upstream end that extends axially into a respective outlet of a respective tubular passage of the plurality of tubular passages.

One embodiment of the present disclosure is directed to a bundled tube fuel nozzle assembly. The bundled tube fuel nozzle assembly includes a fuel plenum body defining a forward wall, an aft wall, an outer band, a fuel plenum defined within the fuel plenum body and a plurality of tubular passages that extends from the forward wall, through the fuel plenum and to the aft wall. The fuel plenum body is formed as a singular body. A plurality of tube extensions extends downstream from the plurality of tubular passages. Each tube extension of the plurality of tube extensions is coaxially aligned with a respective outlet of a respective tubular passage of the plurality of tubular passages. Each tube extension includes a respective upstream end that is fixedly connected to the fuel plenum body.

Another embodiment of the present disclosure is a combustor. The combustor includes an end cover coupled to an outer casing and a bundled tube fuel nozzle assembly disposed within the outer casing and fluidly coupled to the end cover via one or more fluid conduits. The bundled tube fuel nozzle assembly includes a fuel plenum body that defines a forward wall, an aft wall, an outer band, a fuel plenum defined within the fuel plenum body and a plurality of tubular passages that extends from the forward wall, through the fuel plenum and to the aft wall. The fuel plenum body is formed as a singular body. A plurality of tube extensions extends downstream from the plurality of tubular passages. At least one tube extension of the plurality of tube extensions includes an upstream end that extends axially into a respective outlet of a respective tubular passage of the plurality of tubular passages.

Those of ordinary skill in the art will better appreciate the features and aspects of such embodiments, and others, upon review of the specification.

### BRIEF DESCRIPTION OF THE DRAWINGS

A full and enabling disclosure of the of various embodiments, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present disclosure;

FIG. 2 is a simplified cross-section side view of an exemplary combustor as may incorporate various embodiments of the present disclosure;

FIG. 3 is a cross sectioned side view of an exemplary bundled tube fuel nozzle assembly according to various embodiments of the present disclosure; and

FIG. 4 is an enlarged cross sectioned side view of a portion of the exemplary bundled tube fuel nozzle assembly as shown in FIG. 3 according to at least one embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel and/or coaxially aligned to an axial centerline of a particular component.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of a bundled tube fuel nozzle assembly for a land based power generating gas turbine combustor for purposes of illustration, one of ordinary skill in the art will readily appreciate that embodiments of the present disclosure may be applied to any style or type of combustor for a turbomachine and are not limited to combustors or combustion systems for land based power generating gas turbines unless specifically recited in the claims.

Referring now to the drawings, FIG. 1 illustrates a schematic diagram of an exemplary gas turbine 10. The gas turbine 10 generally includes an inlet section 12, a compressor 14 disposed downstream of the inlet section 12, at least one combustor 16 disposed downstream of the compressor 14, a turbine 18 disposed downstream of the combustor 16 and an exhaust section 20 disposed downstream of the turbine 18. Additionally, the gas turbine 10 may include one or more shafts 22 that couple the compressor 14 to the turbine 18.

During operation, air 24 flows through the inlet section 12 and into the compressor 14 where the air 24 is progressively compressed, thus providing compressed air 26 to the combustor 16. At least a portion of the compressed air 26 is mixed with a fuel 28 within the combustor 16 and burned to produce combustion gases 30. The combustion gases 30 flow from the combustor 16 into the turbine 18, wherein energy (kinetic and/or thermal) is transferred from the combustion gases 30 to rotor blades (not shown), thus causing shaft 22 to rotate. The mechanical rotational energy may then be used for various purposes such as to power the compressor 14 and/or to generate electricity. The combustion gases 30 exiting the turbine 18 may then be exhausted from the gas turbine 10 via the exhaust section 20.

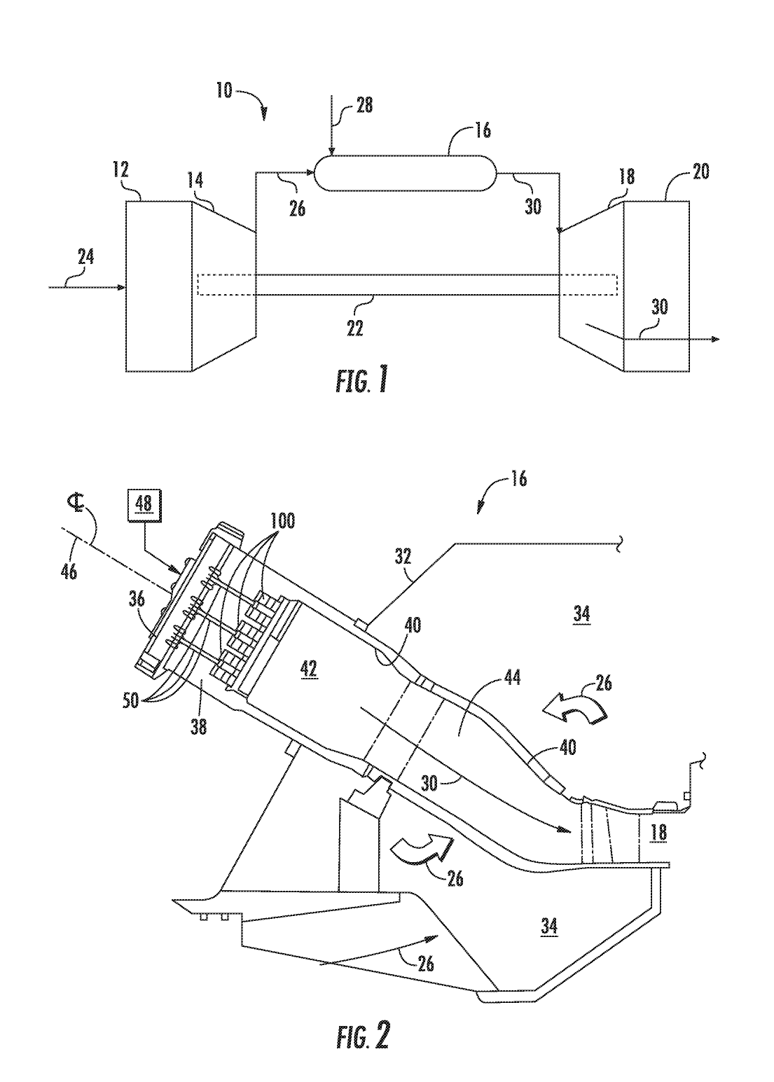

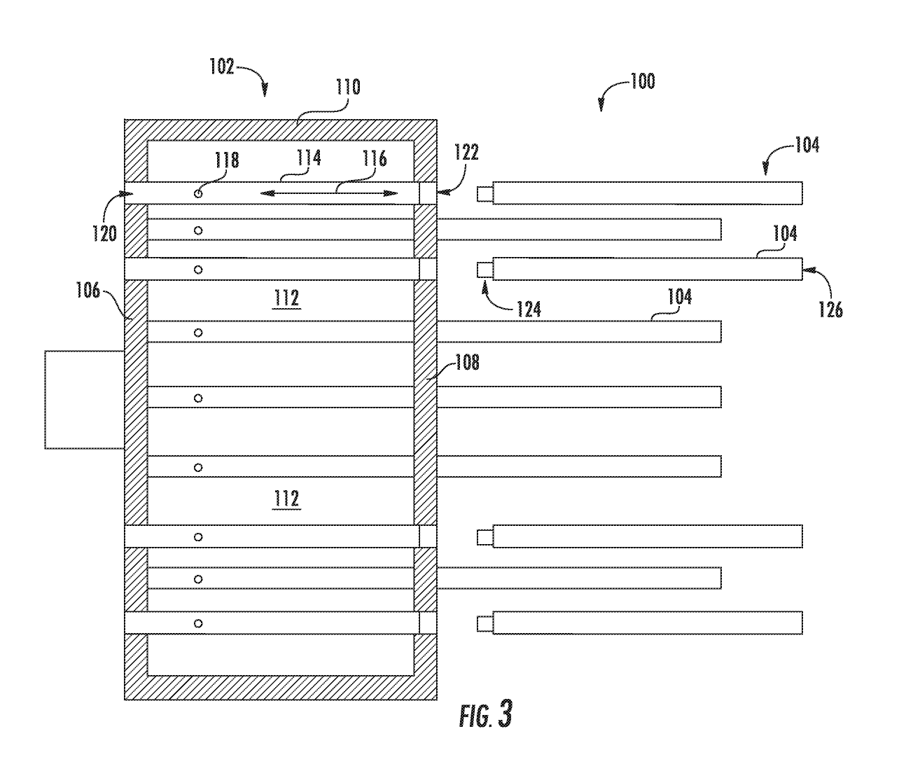

As shown in FIG. 2, the combustor 16 may be at least partially surrounded an outer casing 32 such as a compressor discharge casing. The outer casing 32 may at least partially define a high pressure plenum 34 that at least partially surrounds various components of the combustor 16. The high pressure plenum 34 may be in fluid communication with the compressor 14 (FIG. 1) so as to receive the compressed air 26 therefrom. An end cover 36 may be coupled to the outer casing 32. In particular embodiments, the outer casing 32 and the end cover 36 may at least partially define a head end volume or portion 38 of the combustor 16.

In particular embodiments, the head end portion 38 is in fluid communication with the high pressure plenum 34 and/or the compressor 14. One or more liners or ducts 40 may at least partially define a combustion chamber or zone 42 for combusting the fuel-air mixture and/or may at least partially define a hot gas path through the combustor as indicated by arrow 44, for directing the combustion gases 30 towards an inlet to the turbine 18.

In various embodiments, the combustor 16 includes at least one bundled tube fuel nozzle assembly 100. As shown in FIG. 2, the bundled tube fuel nozzle assembly 100 is disposed within the outer casing 32 downstream from and/or axially spaced from the end cover 36 with respect to axial centerline 46 of the combustor 16 and upstream from the combustion chamber 42. In particular embodiments, the bundled tube fuel nozzle assembly 100 is in fluid communication with a gas fuel supply 48 via one or more fluid conduits 50. In particular embodiments, the fluid conduit(s) 50 may be fluidly coupled and/or connected at one end to the end cover 36.

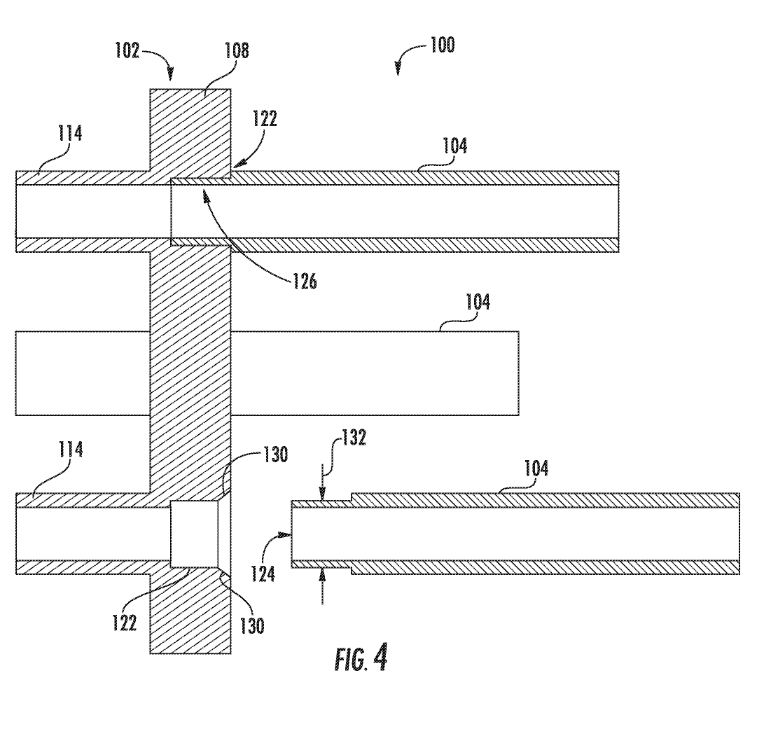

FIG. 3 provides a partially exploded cross sectioned side view of an exemplary bundled tube fuel nozzle assembly 100 according to various embodiments of the present disclosure. In various embodiments, as shown in FIG. 3, the bundled tube fuel nozzle assembly 100 includes a fuel plenum body 102 and a plurality of tube extensions 104. The fuel plenum body 102 defines an upstream or forward wall 106, a downstream or aft wall 108 and an outer band or sleeve 110 that extends between the forward wall 106 and the aft wall 108. The fuel plenum body 102 is not limited to any particular shape unless otherwise recited in the claims. For example, in particular embodiments, the fuel plenum body 102 may be disk shaped or may be wedge shaped.

As shown in FIG. 3, the bundled tube fuel nozzle assembly 100 further defines a fuel plenum 112 defined within the fuel plenum body 102 and a plurality of tubes or tubular passages 114 that extends from the forward wall 106, through the fuel plenum 112 and to the aft wall 108. In at least one embodiment, the fuel plenum 112 is at least partially defined between the forward wall 106, the aft wall 108 and the outer band 110. Each tubular passage 114 defines a respective flow passage or premix flow passage 116 through the fuel plenum body 102. In particular embodiments, one or more of the premix flow passages 116 is in fluid communication with the fuel plenum 112 via one or more fuel ports 118 defined in one or more of the tubular passages 114. Each tubular passage 114 includes a respective inlet 120 defined along the forward wall 106. Each tubular passage 114 also includes a respective outlet 122 defined along the aft wall 108.

In at least one embodiment, the fuel plenum body 102 is formed as a singular body. In other words, the forward wall 106, the aft wall 108, the outer band 110, the tubular passages 116 and the fuel plenum 112 may all be formed as a singular body. For example, in particular embodiments, the fuel plenum body 102 is formed via an additive manufacturing process. The terms additive manufacturing or additively manufactured as used herein refers to any process which results in a useful, three-dimensional object and includes a step of sequentially forming the shape of the object one layer at a time. Additive manufacturing processes may include three-dimensional printing (3DP) processes, laser-net-shape manufacturing, direct metal laser sintering (DMLS), direct metal laser melting (DMLM), plasma transferred arc, freeform fabrication, etc.

As shown in FIG. 3, the plurality of tube extensions 104 extends axially outwardly or downstream from the aft wall 108 and downstream from the plurality of tubular passages 114. In at least one embodiment, each tube extension 104 may be coaxially aligned with a respective tubular passage 114. Each tube extension 104 of the plurality of tube extensions 104 includes an upstream end or tube extension inlet 124 that is axially spaced from a downstream end or tube extension outlet 126.

FIG. 4 provides a cross sectioned side view of a portion of the bundled tube fuel nozzle assembly 100 as shown in FIG. 3 with one tube extension 104 assembled to the fuel plenum body 102 and with one tube extension 104 exploded away from the fuel plenum body 102, according to at least one embodiment of the present disclosure. In various embodiments, the upstream end 124 of each tube extension 104 is fixedly connected to and/or at least partially sealed against the fuel plenum body 102. For example, the upstream end 124 of each tube extension 104 may be brazed, welded or otherwise fixedly connected to the fuel plenum body 102. In at least one embodiment, each tube extension 104 is in fluid communication with a corresponding tubular passage 114 such that the tubular passage 114 and the respective tube extension 104 form a continuous premix flow passage 116 that extends from the respective tubular passage inlet 120 (FIG. 3) defined along the forward wall 106 of the fuel plenum body 102 to the tube extension outlet 126 of the corresponding tube extension 104.

In at least one embodiment, as shown in FIG. 4, the outlet 122 of at least one respective tubular passage 114 and/or the aft wall of the fuel plenum body 102 is counterbored 128. The counterbore 128 facilitates insertion into and/or alignment of each tube extension 104 with a respective outlet 122 of a respective tubular passage 114. In particular embodiments, a rim portion 130 of the outlet 122 of at least one respective tubular passage 114 is tapered or converges radially inwardly from the aft wall 108 towards the forward wall 106 (FIG. 3).

In particular embodiments, as shown in FIG. 4, the upstream end 124 of at least one tube extension 104 of the plurality of tube extensions 104 extends axially into and/or is seated within a respective outlet 122 of a corresponding tubular passage 114. In particular embodiments, as shown in FIG. 4, at least one tube extension 104 of the plurality of tube extensions 104 has a reduced outer diameter 132 at or proximate to the upstream end 124 when compared to the outer diameter of the same tube at or proximate to the respective downstream end or outlet 126 to allow for installation into the corresponding outlet 122 and to reduce or minimalize the required diameter of the corresponding outlet 122.

In operation, compressed air 26 from the high pressure plenum 34 flows into the tubular passages 116 via inlets 122. Fuel is supplied to the fuel plenum 112 via one or more of the fluid conduits 50. The fuel is then injected into each premix flow passage 116 via fuel ports 120. The fuel and compressed air mix within the tubular passages 116 and the tube extensions 104 before flowing out of the tube extension outlets 128 into the combustion zone 42 where it is burned to produce the combustion gases 30.

The bundled tube fuel nozzle assembly 100 shown and described herein provides various technical benefits over existing bundled tube fuel nozzle assemblies. For example, forming the fuel plenum body 102 as a singular component significantly reduces the likelihood of a fuel leak from the fuel plenum by decreasing the number of braze joints normally required to seal the fuel plenum. Brazing the tube extensions 104 into the respective outlets 122 forms continuous surfaces between the fuel plenum body 102 and the tube extensions, thereby allowing for a wider fuel range capability when compared to particular known bundled tube fuel nozzle assembly configurations. By brazing in the tube extensions 104, flame-holding capability of the bundled tube fuel nozzle assembly 100 is increased significantly. With the brazed in tube extensions 104, the fuel plenum body 102 may accept a wide range of fuel types.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A bundled tube fuel nozzle assembly, comprising:
a fuel plenum body defining a forward wall, an aft wall, an outer band, a fuel plenum defined within the fuel plenum body and a plurality of tubular passages that extends from the forward wall, through the fuel plenum and to the aft wall, wherein the fuel plenum body is formed as a singular body; and
a plurality of tube extensions that extends downstream from the plurality of tubular passages, wherein at least one tube extension of the plurality of tube extensions includes an upstream end that extends axially into a respective outlet of a respective tubular passage of the plurality of tubular passages.

2. The bundled tube fuel nozzle assembly as in claim 1, wherein the at least one tube extension and the respective tubular passage forms a continuous premix flow passage through the bundled tube fuel nozzle assembly.

3. The bundled tube fuel nozzle assembly as in claim 1, wherein the upstream end of the at least one tube extension is brazed or welded to the fuel plenum body.

4. The bundled tube fuel nozzle assembly as in claim 1, wherein a portion of the upstream end of the at least tube extension has a reduced outer diameter.

5. The bundled tube fuel nozzle assembly as in claim 1, wherein the outlet of the respective tubular passage is counterbored.

6. The bundled tube fuel nozzle assembly as in claim 1, wherein one or more of the tubular passages of the plurality of tubular passages is in fluid communication with the fuel plenum via one or more fuel ports.

7. The bundled tube fuel nozzle assembly as in claim 1, wherein each tube extension of the plurality of tube extensions is coaxially aligned with a respective tubular passage of the plurality of tubular passages.

8. The bundled tube fuel nozzle assembly as in claim 1, wherein the fuel plenum body is formed as a singular body via an additive manufacturing process.

9. A bundled tube fuel nozzle assembly, comprising:
a fuel plenum body defining a forward wall, an aft wall, an outer band, a fuel plenum defined within the fuel plenum body and a plurality of tubular passages that extends from the forward wall, through the fuel plenum and to the aft wall, wherein the fuel plenum body is formed as a singular body; and
a plurality of tube extensions that extends downstream from the plurality of tubular passages, wherein each tube extension of the plurality of tube extensions is coaxially aligned with a respective outlet of a respective tubular passage of the plurality of tubular passages and wherein each tube extension includes a respective upstream end fixedly connected to the fuel plenum body.

10. The bundled tube fuel nozzle assembly as in claim 9, wherein each tube extension and each respective tubular passage forms a respective premix flow passage.

11. The bundled tube fuel nozzle assembly as in claim 9, wherein the respective upstream end of each tube extension is brazed or welded to the fuel plenum body.

12. The bundled tube fuel nozzle assembly as in claim 9, wherein the upstream end of each tube extension of the plurality of tube extensions has a reduced outer diameter.

13. The bundled tube fuel nozzle assembly as in claim 9, wherein an outlet of each tubular passage is counterbored.

14. The bundled tube fuel nozzle assembly as in claim 9, wherein one or more of the tubular passages is in fluid communication with the fuel plenum via one or more fuel ports.

15. The bundled tube fuel nozzle assembly as in claim 9, wherein the fuel plenum body is formed as a singular body via an additive manufacturing process.

16. A combustor, comprising:
an end cover coupled to an outer casing;
a bundled tube fuel nozzle disposed within the outer casing and coupled to the end cover via one or more fluid conduits, wherein the bundled tube fuel nozzle comprises:
a fuel plenum body defining a forward wall, an aft wall, an outer band, a fuel plenum defined within the fuel plenum body and a plurality of tubular passages that extends from the forward wall, through the fuel plenum and to the aft wall, wherein the fuel plenum body is formed as a singular body; and
a plurality of tube extensions that extends downstream from the plurality of tubular passages, wherein at least one tube extension of the plurality of tube extensions includes an upstream end that extends axially into a respective outlet of a respective tubular passage of the plurality of tubular passages.

17. The combustor as in claim 16, wherein each tube extension and each respective tubular passage forms a respective premix flow passage.

18. The combustor as in claim 16, wherein the respective upstream end of each tube extension is brazed or welded to the fuel plenum body.

19. The combustor as in claim 16, wherein an outlet of each tubular passage is counterbored.

20. The combustor as in claim 16, wherein the fuel plenum body is formed as a singular body via an additive manufacturing process.
